(19) United States
(12) Patent Application Publication
(10) Pub. No.: US 2008/0155033 A1
(43) Pub. Date: Jun. 26, 2008

(54) E-mail Address Management

(75) Inventors: Jiten Bhalgat, Marlton, NJ (US); Peter Carag, Phoenix, AZ (US); Tracey Walsh, Pingree Grove, IL (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/614,788

(22) Filed: Dec. 21, 2006

(51) Int. Cl. G06F 15/16

(52) U.S. Cl. 709/206

(57) ABSTRACT

The present invention provides a system, a method, and a computer program for providing e-mail address management. E-mail address management is a tool for aggregating one or many e-mail addresses under a unique identifier that simplifies the process of managing and/or applying those email addresses individually. The invention was conceived in conjunction with a pre-trip authorization application used to review and approve travel-related expenses by a company-designated reviewer and authorizer prior to a start of travel. A reservation request is received. A traveler profile based on the reservation request is retrieved. The traveler profile has a unique identifier. A reservation is created. The reservation includes the reviewer group identifier. A reviewer e-mail address is determined from the table housing the reviewer group identifier codes. The reservation is sent to the reviewer e-mail address. A review result is received from the reviewer e-mail address.

### FIELD OF THE INVENTION

The present invention relates to travel and, more particularly, to automating a process of associating a traveler to a specific reviewer who is tasked with reviewing/authorizing a travel request.

### BACKGROUND OF THE INVENTION

Pre-trip approval is a tool to review and approve travel-related expenses by a company-designated reviewer and authorizer prior to a start of travel. An authorizer is a person who has been granted authority to approve incurrence of travel-related expenses by the traveler. Reservation databases are used to maintain records of information about travelers, such as a traveler profile. A traveler profile is a record that contains information about a traveler. One field in the traveler profile is an authorizer field. The authorizer field provides details about the authorizer, such as a name and an e-mail address.

When the authorizer changes from one person to another, the authorizer field in each affected individual traveler profile must be edited to reflect the change. Often, when the authorizer changes, thousands of individual traveler profiles must be edited. This profile maintenance task is tedious and expensive.

Current systems also have a limited number of authorizer fields. This limits the number of authorizers who can be associated with each traveler. Thus, a large group of authorizers cannot be associated with the traveler profile.

What is needed is a system, method, and computer product that improves upon traditional e-mail address management methods.

### BRIEF SUMMARY OF THE INVENTION

The present invention provides a system, a method, and a computer program for providing e-mail address management. E-mail address management is a tool for aggregating one or many e-mail addresses under a unique identification code that simplifies the process of managing and/or applying those email addresses individually.

The invention was conceived in conjunction with a pre-trip authorization application.

Here is an example of how this email address management tool can be applied. A reservation request is received. A traveler profile based on the reservation request is retrieved. The traveler profile has a reviewer group identifier. This reviewer group identifier represents one or many email addresses that are maintained in a separate table.

A reservation is created. The reservation includes the reviewer group identifier. At least one reviewer e-mail address is determined from the reviewer group identifier. The reservation (or a notification associated with the reservation) is sent to the reviewer(s) e-mail addresses associated with the reviewer group identifier. In some instances, a reviewer may be associated with the group identifier only for purposes of being notified of the reservation request. In other instances, approval from the reviewer may be required to approve the travel. When approval is required, a review result is received from the reviewer e-mail address.

For any reviewers who are required authorizers, the review result includes an approval or disapproval. For any reviewers whose authorization is not required, the result may include an indication that the reviewer has reviewed the reservation request. However, no review result is required from a reviewer whose authorization is not required.

### BRIEF DESCRIPTION OF THE DRAWINGS/FIGURES

The accompanying drawings, which are incorporated herein and form a part of the specification, illustrate the invention and, together with the description, further serve to explain the principles of the invention and to enable a person skilled in the pertinent art to make and use the invention:

FIG. 1A is a high-level flow diagram that illustrates a method for initializing an e-mail address management system;

FIG. 1B is a high-level flow diagram that illustrates another method for initializing the e-mail address management system;

FIG. 2 is an exemplary structure for a group of reviewers having a multi-level approval structure;

FIG. 3A is a high-level flow diagram that illustrates a method for providing e-mail address management;

FIG. 3B is a high-level flow diagram that illustrates a method of production operation;

FIG. 4A is a flow diagram illustrating a method of high-level system flow of production operation;

FIG. 4B is a continuation of FIG. 4A; and

FIG. 5 illustrates that the invention is directed toward a computer system capable of carrying out the functionality described herein.

The invention will be described with reference to the accompanying drawings. The drawing in which an element first appears is typically indicated by the leftmost digit(s) in the corresponding reference number.

### DETAILED DESCRIPTION OF THE INVENTION

The present invention is a system, method, and computer product that provides several advantages over traditional e-mail address management systems by solving problems of the traditional systems. One of the advantages provided is that a change in a reviewer may be made to a single record, without having to update each individual traveler's profile. Also, as many reviewers as desired may be associated with a traveler's profile. Another advantage is a reduction in database maintenance costs. Further, any member of a group of reviewers is able to review incurrence of travel expenses by a traveler.

While specific examples and configurations are described, it should be understood that this is done for illustrative purposes only. Other implementations may be used without departing from the spirit and scope of the present invention. This invention may be employed in a variety of other applications.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in an embodiment, that feature, structure, or characteristic may be effected with other embodiments of the invention whether or not explicitly described.

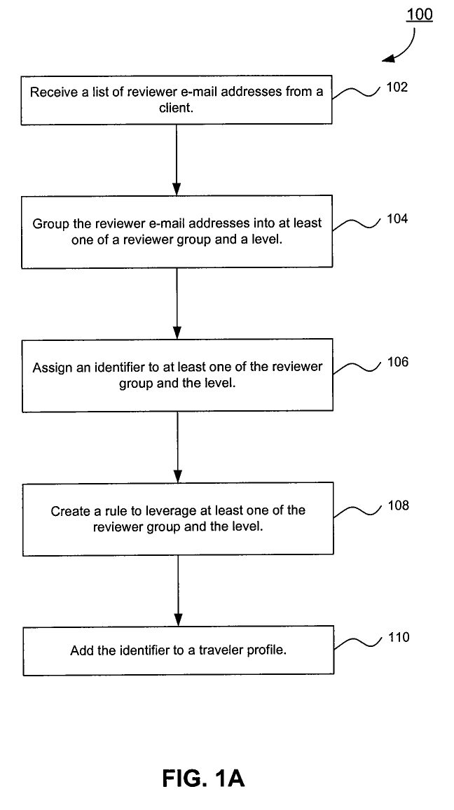

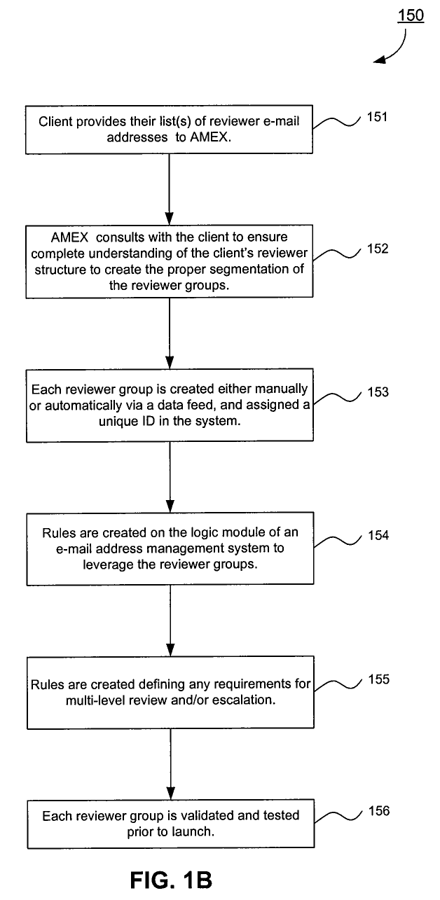

The invention is now described with reference to the figures. FIG. 1A is a high-level flow diagram that illustrates a method 100 for initializing an e-mail address management system. In step 102, a list of reviewers e-mail addresses is received. The list may be received from a client. In some instances, a reviewer is a person, group of people, or some other entity whose approval may be required for travel. As used herein, the term “reviewer” also includes a person, group of people, or other entity who is provided with notification of the travel but whose approval may not be required. The system and method disclosed herein can accommodate both reviewers who merely review and reviewers whose authorization is required. A reviewer whose authorization is required is also called an “authorizer.”

In step 104, the reviewers e-mail addresses are grouped into a reviewer group and/or a level. In step 106, an identifier is assigned to the reviewer group and/or the level. In step 108, a rule to leverage the reviewer group and/or the level is created. In step 110, the identifier is added to a traveler's profile.

The method 100 for initializing the e-mail address management system may further validate each reviewer group prior to production use. A rule that defines requirements for a multi-level approval may be created. For example, a rule can define a requirement for escalation from a first level to a second level.

FIG. 1B is a high-level flow diagram that illustrates another method for initializing the e-mail address management system. In step 151, a client provides their list(s) of reviewers e-mail addresses to a travel-related service company, such as American Express Travel Related Services Company, Inc. (AMEX). In step 152, the travel-related service company consults with the client to ensure complete understanding of the client's reviewer structure to create a proper segmentation of the reviewer groups. In step 153, each reviewer group is created either manually or automatically via a data feed. Each reviewer group is assigned a unique identifier (ID) in the e-mail address management system. The ID may be, for example, any combination of alphanumeric characters. In step 154, rules are created on a logic module of the e-mail address management system to leverage the reviewer groups. In step 155, rules are created to define any requirements for multi-level notifications/approvals. The rules may define, for example, requirements for escalation from a first level to a second level. In step 156, each reviewer group is validated. Each reviewer group is tested prior to production use. Multiple reviewers may be required in this flow. A single reviewer may take the place of multiple reviewers.

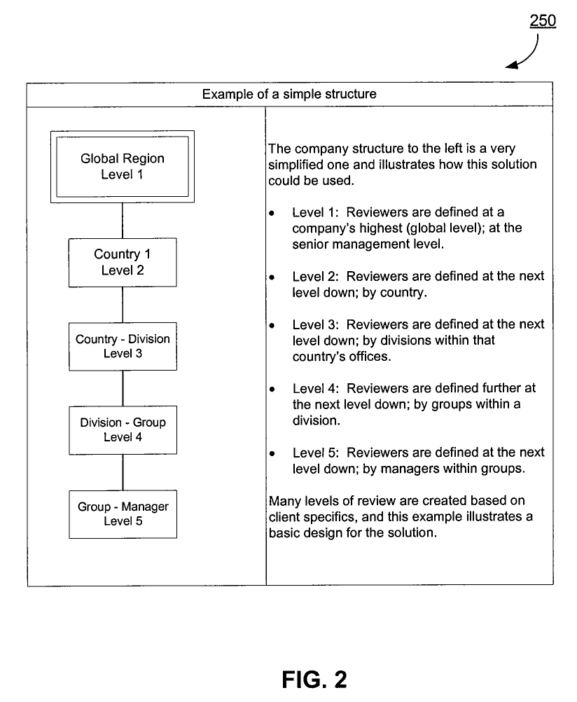

FIG. 2 is an exemplary structure for a group of reviewers having the multi-level approval structure 250. Five levels are shown in this example. Level one is the highest level of reviewers. Level five is the lowest level of reviewers. The levels may prevent a reviewer from reviewing/authorizing travel for travelers who are outside of a population of travelers for which the reviewer is empowered to authorize. The multi-level approval structure has at least two levels of reviewers. The number of levels and structure of groups is flexible and may be implemented to meet specific needs of a client. Each level may consist of a primary reviewer, a backup reviewer, and/or an alternate reviewer. The reviewer is not limited to a single group or level. The reviewer may be a member of multiple groups. The reviewer may be a member of multiple levels. Each level and/or group of reviewers is assigned an identifier (ID) that is unique. Multiple groups may be used to acquire multi-level notifications/approvals. The e-mail address management tool may provide for escalation of notifications/approvals, for example, across multiple groups or multiple levels.

The client may access the e-mail address management tool to change reviewer(s) e-mail addresses, levels, and groups. Clients may upload data files to update the reviewer(s), levels, and groups. A graphical user interface may be provided so that a client may manage reviewer(s) e-mail addresses, levels, and groups. Updates to reviewer(s) e-mail addresses, levels, and groups may be available to all reservations immediately.

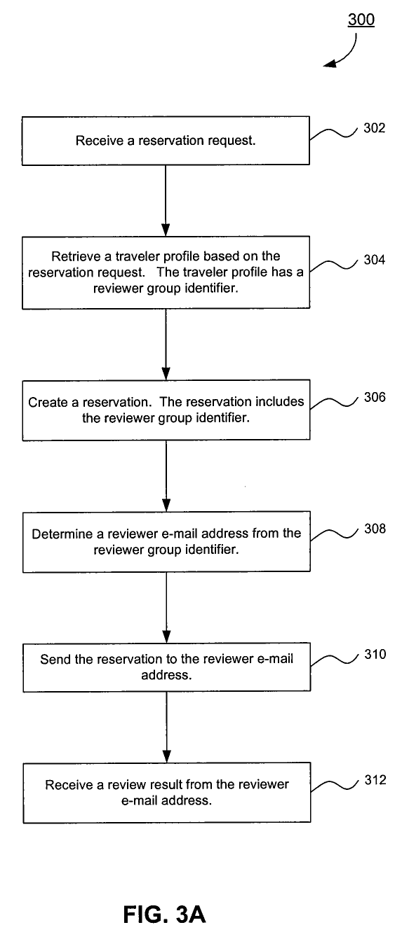

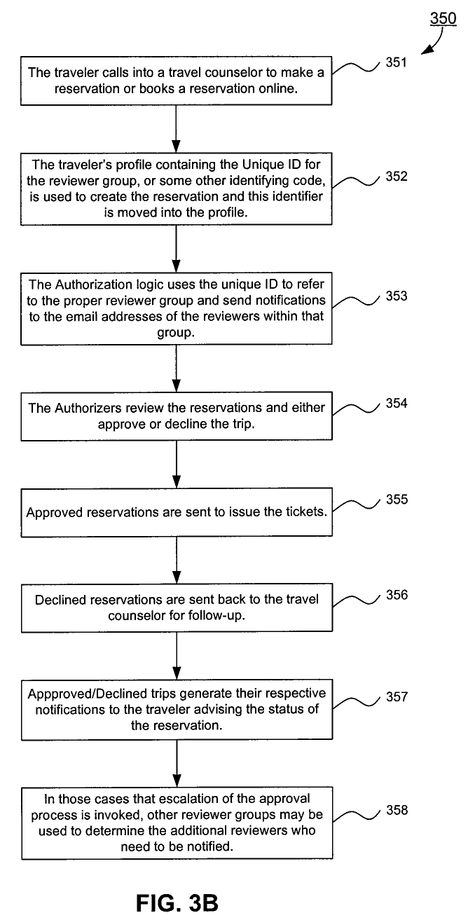

FIG. 3A is a high-level flow diagram that illustrates a method 300 for providing e-mail address management. In step 302, a reservation request is received at, for example, the travel-related services company such as AMEX. In step 304, the traveler profile is retrieved based on the reservation request. The traveler profile has a reviewer group identifier. In step 306, a reservation is created. The reservation includes the reviewer group identifier. In step 308, a reviewer e-mail address is determined from the reviewer group identifier. In step 310, the reservation is sent to the reviewer e-mail address. In step 312, a review result may be received from the reviewer e-mail address.

The review result may be an approval or a declination. If the review result is an approval, a ticket is issued. If the review result is a declination, a travel counselor may be notified. A declined notice may be sent via electronic mail. The traveler may change the reservation request.

The method for providing e-mail address management 300 may further determine if escalation is required. Escalation is a process where at least two levels of review and/or authorization are required to determine if the reservation is to be approved, changed, or declined. If escalation is required, a second reviewer group is determined from the reviewer group identifier. The reservation is sent via e-mail to a second reviewer in the second reviewer group. An authorization decision result is received from the second reviewer. The second reviewer group may be in a higher level in the multi-level approval structure than the first reviewer group.

FIG. 3B is a high-level flow diagram that illustrates a method 350 of production operation of an embodiment of the invention. In step 351, the traveler calls the travel counselor to make the reservation. Alternatively, the traveler may book the reservation online. In step 352, the traveler's profile containing the ID for the reviewer group is used to create the reservation. The ID is in the traveler's profile. Alternately, another identifying code may be used in place of the ID. In step 353, authorization logic uses the ID to refer to the proper reviewer group. The authorization logic sends a notice to the email addresses of the reviewer(s) within that group. The authorization logic is part of the e-mail address management tool. In step 354, the reviewer(s) evaluates the reservation. The reviewer(s) either approve or decline the trip. In step 355, approved reservations are processed. In step 356, declined reservations held until fixed or cancelled. In step 357, the traveler is advised of the status of the reservation as approved or declined. In step 358, in cases where escalation of the approval process is required, other reviewer groups determine the additional reviewer(s) who are notified.

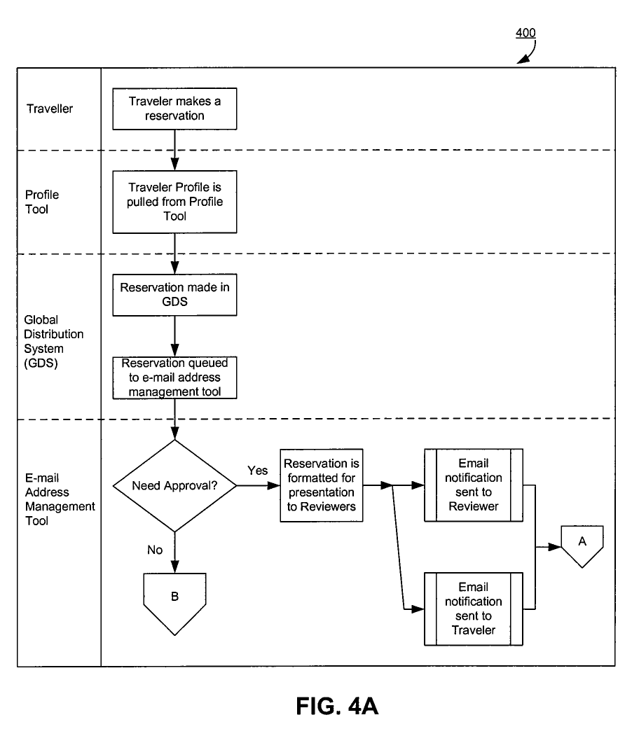

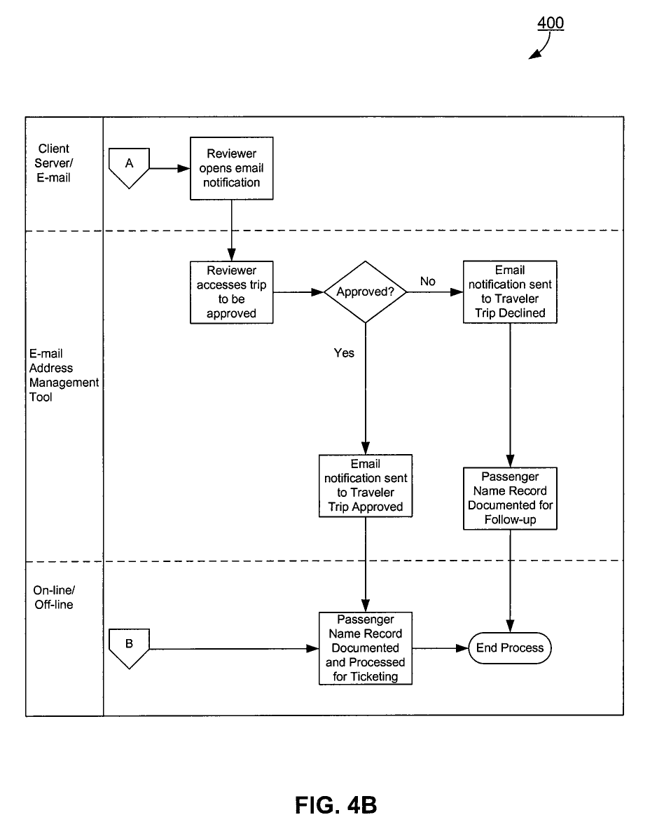

FIGS. 4A and 4B are flow diagrams illustrating a method 400 of high-level system flow of production operation of an embodiment of the invention.

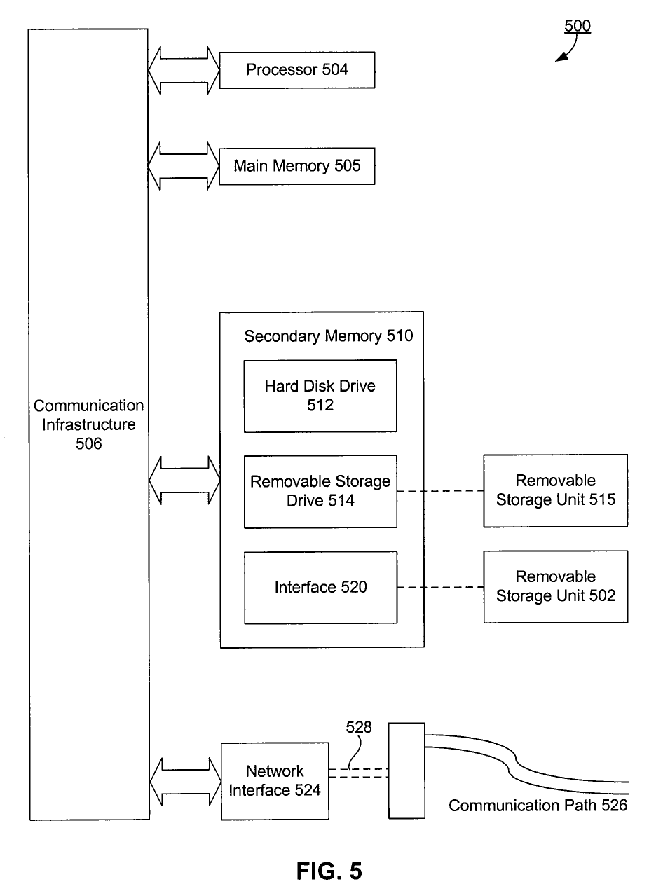

Any part or step of the present invention may be implemented using hardware, software or a combination thereof and may be implemented in a computer system or other processing system. FIG. 5 illustrates that the invention is directed toward a computer system 500 capable of carrying out the functions described herein. The computer system 500 includes a processor 504. The processor 504 is connected to a communication infrastructure 506 (e.g., a communications bus or network). Various software embodiments are described in terms of this exemplary computer system. Other computer systems and/or architectures may be used to implement the e-mail address management tool.

The computer system 500 can include a display interface 502 that forwards graphics, text, and other data from the communication infrastructure 506 (or from a frame buffer not shown) for display on the display unit 530.

The computer system 500 also includes a main memory 508. The computer system 500 may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518. Removable storage unit 518 may be a floppy disk, magnetic tape, optical disk, etc. which is read by and written to by removable storage drive 514. The removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, the removable storage unit 518 and an interface 520. Examples of the removable storage unit 518 and the interface 520 may include a program cartridge and a cartridge interface (such as that found in video game devices), a removable memory chip (such as an erasable programmable read only memory (EPROM), or programmable read only memory (PROM)) and associated socket, and the like. The interface 520 transfers software and data from the removable storage unit 518 to the computer system 500.

The computer system 500 may also include a communication interface 524. The communication interface 524 allows software and data to be transferred between computer system 500 and external devices. Examples of the communication interface 524 may include a modem, a network interface (such as an Ethernet card), a communications port, a Personal Computer Memory Card International Association (PCMCIA) slot and card, etc. Software and data transferred via the communication interface 524 are in the form of signals 528 which may be electronic, electromagnetic, optical or other signals capable of being received by the communication interface 524. The signals 528 are provided to communications interface 524 via a channel 526. The channel 526 carries the signals 528 and may be implemented using wire, fiber optics, a telephone line, a cellular link, a radio frequency (RF) link, and the like.

The terms “computer program medium,” “computer usable medium,” and “computer-readable medium” are used interchangeably to refer to media such as removable storage drive 514 and the hard disk drive 512. The computer program products provide instructions to the computer system 500. The invention is directed to such computer program products.

A computer program, also referred to as computer control logic, is stored in the main memory 508 and/or the secondary memory 510. The computer program may also be received via the communication interface 524. The computer program enables the computer system 500 to perform the features of the present invention. The computer program enables the processor 504 to perform the features of the present invention. Accordingly, the computer program is a controller of the computer system 500.

In an embodiment where the invention is implemented using software, the software may be stored in the computer program product and loaded into the computer system 500 using the removable storage drive 514, the hard drive 512 or the communication interface 524. The control logic (software), when executed by the processor 504, causes the processor 504 to perform the functions of the invention as described herein.

The invention may be implemented primarily in hardware using, for example, hardware components such as application specific integrated circuits (ASICs). The invention may be implemented using a combination of both hardware and software.

While various embodiments of the present invention have been described above, they have been presented by way of example, and not limitation. Various changes in form and detail may be made without departing from the spirit and scope of the present invention. Thus, the present invention should not be limited by any of the above described exemplary embodiments. The present invention should be defined only in accordance with the following claims and their equivalents.

In addition, the figures, which highlight the functionality and advantages of the present invention, are presented only as examples. The architecture of the present invention is sufficiently flexible and configurable that it may be utilized in ways other than those shown in the figures.

What is claimed is:

1. A method for e-mail address management, comprising:
receiving a reservation request;
retrieving a traveler profile based on said reservation request, wherein said traveler profile has a reviewer group identifier;
creating a reservation, wherein said reservation includes said reviewer group identifier;
determining a reviewer e-mail address from said reviewer group identifier;
sending said reservation to said reviewer e-mail address; and
receiving a review result from said reviewer e-mail address.

2. The method of claim 1, further comprising:
determining if escalation is required; and
if escalation is required, determining a second reviewer group with said reviewer group identifier, sending the reservation to a second reviewer in said second reviewer group, and receiving a review decision result from said second reviewer.

3. A method for initializing an e-mail address management system, comprising:
receiving a list of reviewer e-mail addresses;
grouping said reviewer e-mail addresses into at least one of a reviewer group and a level;
assigning an identifier to at least one of said reviewer group and said level;
creating a rule to leverage at least one of said reviewer group and said level; and
adding said identifier to a traveler profile to initialize the e-mail address management system.

4. The method of claim 3, further comprising validating said reviewer group prior to production use.

5. The method of claim 3, further comprising creating a rule that defines a requirement for a multi-level approval.

6. The method of claim 5, wherein said rule defines a requirement for escalation from a first level to a second level.

7. A computer-readable medium carrying at least one instruction for execution by at least one processor to perform e-mail address management, the instructions when executed, cause performance of the steps of:
receiving a reservation request;
retrieving a traveler profile based on said reservation request, wherein said traveler profile has a reviewer group identifier;
creating a reservation, wherein said reservation includes said reviewer group identifier;
determining a reviewer e-mail address from said reviewer group identifier;
sending said reservation to said reviewer e-mail address; and
receiving a review result from said reviewer e-mail address.

8. The medium of claim 7, further carrying an instruction to cause performance of:
determining if escalation is required; and
if escalation is required, determining a second reviewer group with said reviewer group identifier, sending the reservation to a second reviewer in said second reviewer group, and receiving a review decision result from said second reviewer.

9. The medium of claim 7, further carrying an instruction to cause performance of:
receiving a list of reviewer e-mail addresses;
grouping said reviewer e-mail addresses into at least one of a reviewer group and a level;
assigning an identifier to at least one of said reviewer group and said level;
creating a rule to leverage at least one of said reviewer group and said level; and
adding said identifier to a traveler profile to initialize an e-mail address management system.

10. The medium of claim 7, further carrying an instruction to cause performance of validating said reviewer group prior to production use.

11. The medium of claim 7, further carrying an instruction to cause performance of creating a rule that defines a requirement for a multi-level approval.

12. The medium of claim 11, wherein said rule defines a requirement for escalation from a first level to a second level.
